(19) United States
(12) Patent Application Publication
(10) Pub. No.: US 2013/0312096 A1
(43) Pub. Date: Nov. 21, 2013

(54) ON-DEMAND DATA SCAN IN A VIRTUAL MACHINE

(71) Applicants: Samuel Larsen, San Carlos, CA (US); Gilad Arie Wolff, San Francisco, CA (US); Oded Horovitz, Palo Alto, CA (US); Lionel Litty, Mountain View, CA (US); Marios Leventopoulos, Palo Alto, CA (US); James Kiryakoza, San Francisco, CA (US)

(72) Inventors: Samuel Larsen, San Carlos, CA (US); Gilad Arie Wolff, San Francisco, CA (US); Oded Horovitz, Palo Alto, CA (US); Lionel Litty, Mountain View, CA (US); Marios Leventopoulos, Palo Alto, CA (US); James Kiryakoza, San Francisco, CA (US)

(73) Assignee: VMware, INC., Palo Alto, CA (US)

(21) Appl. No.: 13/475,758

(22) Filed: May 18, 2012

(51) Int. Cl. G06F 21/00; G06F 9/455; G06F 11/00

(52) U.S. Cl. 726/24; 726/22

(57) ABSTRACT

A system is provided to facilitate on-demand data scan operation in a guest virtual machine. During operation, the system generates an on-demand scan request at a scanning virtual machine, wherein the request specifies a scope for the on-demand scan. The system communicates the on-demand scan request to the guest virtual machine and receives data from the guest virtual machine in response to the request. The system identifies the data as candidate for on-demand scanning and scans the data in furtherance of a security or data integrity objective.

### BACKGROUND

In a computing device, such as a computer or a cell-phone, an endpoint security application typically requires the computing device to meet certain requirements before file access is granted. Endpoint security solutions can include anti-virus (AV), data leak prevention (DLP), and anti-malware applications. These applications are typically installed on a physical computing device. However, installing and maintaining endpoint security application in each computing device can lead to wastage of resources because each software instance consumes disk space, memory, and processing power. Furthermore, in an environment with a large number of computing devices, such as a corporate network, individually installed endpoint security solutions are more difficult to manage.

On the other hand, in a virtual computing environment, these endpoint security solutions can be designed to be more efficient and manageable using endpoint management solutions. In one such endpoint management solution, a single scanning virtual machine (VM) can be used to provide a security solution (e.g., AV scanning) for all other VMs running on the same host. However, existing solutions are only available for on-access data scan. For example, whenever a file is opened on a VM, the content of the file is transmitted to the security VM for scanning

Furthermore, if a VM migrates from one host machine to another host machine during a scan operation, the operation should continue on the target host machine. Consequently, scanning a VM's data from a scanning VM poses a unique challenge of how such scan operations can continue with a new scanning location on a new host machine.

While decoupling endpoint security solutions from VMs brings many desirable features to a virtualized computing environment, some issues remain unsolved.

### SUMMARY

A system is provided to facilitate on-demand data scan operation in a guest virtual machine. During operation, the system generates an on-demand scan request at a scanning virtual machine, wherein the request specifies a scope for the on-demand scan. The system communicates the on-demand scan request to the guest virtual machine and receives data from the guest virtual machine in response to the request. The system specifies which files should be scanned and scans the data in furtherance of a security or data integrity objective. In some embodiments, the parameters used by the system to specify a file can include, but not limited to, a file extension (e.g., text files can be specified using “.txt” extension), file size, and the last time the file has been modified.

Furthermore, during a scan operation, the guest virtual machine receives a request for an on-demand scan from a scanning virtual machine and creates a file event associated with the request. A thin agent on the guest virtual machine intercepts data associated with the file event and communicates the intercepted data to the scanning virtual machine. The agent also stores state information associated with the scan in the guest virtual machine.

### BRIEF DESCRIPTION OF THE FIGURES

FIG. 1A illustrates an exemplary endpoint security solution on a scanning virtual machine coupled to a guest virtual machine via a logical multiplexer.

FIG. 1B illustrates an exemplary communication between a scanning virtual machine and a guest virtual machine.

FIG. 2A illustrates an exemplary endpoint security solution on a scanning virtual machine coupled to a guest virtual machine via a virtualization layer.

FIG. 2B illustrates an exemplary endpoint security solution on a virtualization layer coupled to a guest virtual machine.

FIG. 3A illustrates an exemplary host machine with a scanning virtual machine and a plurality of guest virtual machines, in accordance with an embodiment of the present invention.

FIG. 3B illustrates an exemplary host machine with a plurality of scanning virtual machines and a plurality of guest virtual machines.

FIG. 4 illustrates an exemplary network with a host machine dedicated for scanning virtual machines.

FIG. 5A presents a flowchart illustrating an exemplary process of an on-demand data scan in a scanning virtual machine.

FIG. 5B presents a flowchart illustrating an exemplary process of an endpoint agent in a guest virtual machine facilitating an on-demand data scan.

FIG. 6 illustrates an exemplary migration of a guest virtual machine.

FIG. 7A presents a flowchart illustrating an exemplary process of an endpoint library in a scanning virtual machine discovering a migrating guest virtual machine.

FIG. 7B presents a flowchart illustrating an exemplary process of an endpoint agent in a migrating guest virtual machine providing scan state information.

### DETAILED DESCRIPTION

The following description is presented to enable any person skilled in the art to make and use the disclosed system and method, and is provided in the context of a particular application and its requirements. Various modifications to the disclosed embodiments of the inventive system will be readily apparent to those skilled in the art, and the general principles defined herein may be applied to other embodiments and applications without departing from the spirit and scope of the present invention. Thus, the present invention is therefore not limited to the embodiments shown.

### Overview

As described in the present disclosure, the problem of facilitating endpoint security solutions to perform on-demand data scan on a guest virtual machine (VM) from a scanning VM is solved by incorporating an endpoint agent on the guest VM which provides data to the scanning VM, in response to a scan request. On a machine that hosts both the scanning VM and other guest VMs, security solutions, such as AV and DLP applications, are installed on the scanning VM and are common to all guest VMs. Scanning operations can be triggered either on-access (i.e., automatically triggered whenever data is accessed on a guest VM) or on-demand (i.e., in response to a scan request).

Existing techniques facilitate on-access scanning of guest VMs by the scanning VM. That is, an agent residing on a guest VM automatically provides the data being accessed to the scanning VM for scanning However, a large number of security solutions also need to provide on-demand data scan, which has not be previously available. On-demand scan allows a user or application to request scanning of a specific set of data (e.g., a file, a directory, or a drive), regardless of whether the data is being accessed or not on the guest VM. For example, an AV or DLP solution may request to examine a file on a guest VM in detail, which can be done with an on-demand scan of the file. However, providing on-demand data scan on a guest VM can be difficult because the scan engine resides outside the guest VM. Furthermore, a guest VM under scan may migrate to a new host machine, and, consequently, be under the protection of a new scanning VM. Continuing such scan on a migrating VM can be challenging.

To solve the aforementioned problems, a thin agent (e.g., a low-overhead software process) residing on a guest VM can receive an on-demand scan request initiated by the scan engine of a security application on the scanning VM. The request specifies the scope of the scan (e.g., the files to be scanned). In some embodiments, a user interface on the scanning VM allows a user (e.g., a system administrator) to initiate the scan. In addition, the agent on the guest VM can handle multiple scan requests (which could be initiated by different security applications) and maintain sufficient state information to keep track of different scan requests. The agent spawns a thread for each scan request and manages the request from the thread, thus identifying and servicing individual scan request from multiple security applications or scanning VMs. The spawned thread then identifies one or more files based on the scope of the request, and creates a file event (such as a file-open event) for each identified file within the scan scope. The creation of this file event allows an agent that is designed for on-access scan to be used for on-demand scan, because the file event results in file access, which in turn triggers the agent to intercept the file and send the file content to the scanning VM.

Once the file content reaches the scanning VM, the corresponding bits are handed over to the scan engine of the security solution. The scan engine then performs the requested scan on the bits in furtherance of a security or data integrity objective (e.g., matching certain virus signatures or patterns for data-leak prevention). For example, if the security solution is an AV application, then the scan engine examines the bits for virus signatures. This process of requesting bits and scanning them is repeated until all files within with the scan scope are scanned.

Note that the agent keeps a record of the current scan state information on the guest VM. The scan state information includes, for example, the scope of the scan (e.g., list of files or directories to be scanned), files with completed scans, files currently being scanned, and files yet to be scanned within the scope. The files currently being scanned may be files for which contents have been or are being transmitted to the security application and for which the agent has not yet received an acknowledgement from the security application. In some embodiments, an endpoint library provides the agent with the current state information of the scan and the agent stores the state information in the guest VM. When a guest VM migrates to a new host, the endpoint library of the scanning VM on the new host receives notification about arrival of the new VM and queries the agent on the new guest VM for the scan state information stored therein. The library then receives the state information and determines whether any scan has been previously performed on the guest VM. If so, the library provides the state information to the corresponding security application on the scanning VM, which in turn resumes the scan operation.

More details of the on-access scanning of VMs are provided in U.S. Pat. No. 7,797,748, the disclosure of which is incorporated by reference herein.

In this disclosure, the term “scanning VM” or “security VM” refers to a VM that is responsible for performing scans on bits provided by a guest VM. Any logical entity on a host machine capable of performing a data scan on a guest VM can be referred as a scanning VM. A scanning VM can be a separate VM or embedded in a virtualization layer of a host machine.

The term “guest VM” refers to a VM that has a thin agent for data scanning purposes. Data stored on a guest VM is typically provided to the scanning VM for scanning

The terms “agent” and “endpoint agent” refer to a software process that continues to run in the operating system of a VM. An agent can remain in a “listening” mode to receive any scan request. An agent can also generate file events, intercept bits of a file, and send the intercepted bits to the scanning VM.

The term “thread” is used in a generic sense. Any method that enables parallel execution of code can be referred as a thread. The method can be a process created by a system call (e.g., fork( ))). A thread can be associated with, but not limited to, an object, a method, or a function in a functional programming language.

The terms “endpoint security solution,” “endpoint application,” “endpoint security application,” and “security application” generally refer to a software application that provides certain security functions, such as scanning files for anti-virus or data-leak-prevention purposes. Such applications include, but are not limited to, anti-virus applications, data leak prevention applications, and anti-malware applications. Though the examples in this disclosure are based on software endpoint solutions, this disclosure is not limited to only software based endpoint solutions. Any software or hardware based solution that provides endpoint services can be referred as an endpoint solution.

### Framework

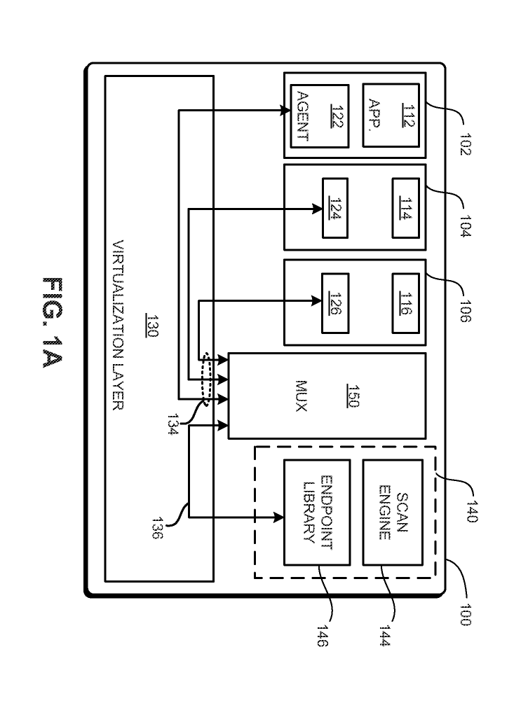

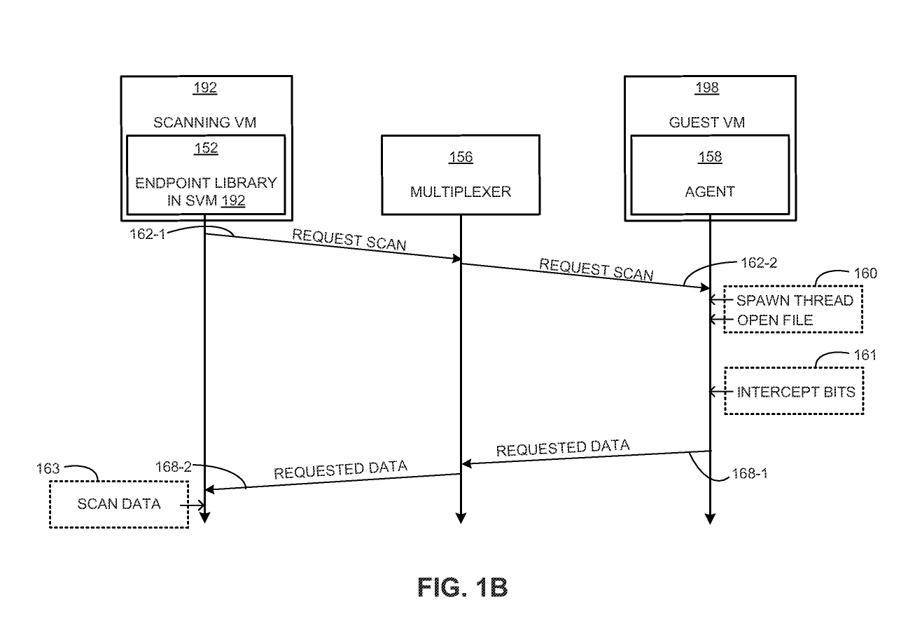

FIG. 1A illustrates an exemplary endpoint security solution on a scanning virtual machine coupled to a guest virtual machine via a logical multiplexer. In this example, a physical host machine 100 has a virtualization layer 130 which enables host machine 100 to host multiple VMs. Virtualization layer 130 can be running on a host operating system. Virtualization layer 130 can also be a virtualization infrastructure which has its own kernel and directly runs on physical host machine 100. For example, such virtualization infrastructure can be the ESX or ESXi platform provided by VMWare. Guest VMs 102, 104, and 106 run on virtualization layer 130. Though only three guest VMs are shown in FIG. 1A, host machine 100 can host any number of guest VMs. Applications 112, 114, and 116 run on guest VMs 102, 104, and 106, respectively. An endpoint agent runs on a respective guest VM. For example, agents 122, 124, and 126 run on guest VMs 102, 104, and 106, respectively.

A scanning VM 140 also runs on host machine 100. Scanning VM 140 includes an endpoint library 146 and a scan engine 144 of a security application, such as an AV program. Endpoint library 146 provides a set of functions (e.g., system calls) which enable scan engine 144 to perform on-demand scan on a respective guest VM. Endpoint library 146 also provides the functions responsible for communicating with a respective agent on the guest VM for the on-demand scan. For example, agent 122 facilitates scan operation on guest VM 102. Endpoint library 146 communicates with agent 122 for performing a scan operation on guest VM 102. Similarly, agents 124 and 126 facilitate scan operation on guest VMs 104 and 106, respectively.

In a system that does not include a separate scanning VM, scan engine 144 will have to reside on a respective guest VM. For example, on guest VM 104, application 114 can be an endpoint application equipped with its scan engine. Consequently, scan operation is initiated and controlled by application 114 on guest VM 102. Similarly, applications 112 and 116 can be endpoint applications on guest VMs 102 and 106, respectively. However, if applications 112, 114, and 116 are endpoint applications, host machine 100 may be burdened with significant resource overhead, because each security application consumes disk space, memory, and processing power. Furthermore, because endpoint security solutions often require frequent updating, the same update is installed for applications 112, 114, and 116. As a result, maintenance of these endpoint applications on guest VMs 102, 104, and 106 is inefficient.

As illustrated in FIG. 1A, only one installation of endpoint application resides on scanning VM 140. Guest VMs in host machine 100 are coupled to scanning VM 140 via a logical multiplexer 150. Logical multiplexer 150 is a communication channel that forwards data between scanning VM 140 and a respective guest VM. In other words, multiplexer 150 acts as a dispatcher between a scanning VM and a guest VM. During operation, scan engine 144 initiates an on-demand scan for guest VM 102. Endpoint library 146 notifies agent 122 on guest VM 102 about the initiated scan via multiplexer 150 (denoted by communications 134 and 136). Agent 122, in turn, creates a file event associated with the notification, and sends end point library 146 with data bits associated with the scan. End point library 146 then provides the bits to scan engine 144 for the scan operation.

FIG. 1B illustrates an exemplary communication between a scanning virtual machine and a guest virtual machine, in accordance with an embodiment of the present invention. During operation, an endpoint library 152 on a scanning VM 192 creates a request for an on-demand scan on a guest VM 198 and sends the request toward agent 158 on guest VM 198. The request specifies the scope of the scan (i.e., the files to be scanned on guest VM 198). Scanning VM 192 then forwards the request to multiplexer 156 (communication 162-1). Multiplexer 156 then identifies target guest VM 198 of the request and forwards the request to guest VM 198 (communication 162-2). In some embodiments, communication 162-1 between scanning VM 152 and multiplexer 156 is performed via a shared memory. In a further embodiment, communication 162-1 is performed using a Virtual Machine Communication Interface (VMCI). Communication 162-2 between multiplexer 156 and guest VM 198 can be performed using a network socket, such as a Transmission Control Protocol (TCP)/Internet Protocol (IP) socket or a User Datagram Protocol (UDP) socket. In further embodiments, communication 162-2 involves a Small Computer System Interface (SCSI) layer communication protocol.

Upon receiving the request, agent 158 keeps track of scanning VM 192 and compartmentalizes the request. Agent 158 then spawns a thread for the request and manages the request from the thread. The spawned thread identifies one or more files on guest VM 198 based on the scope of the request, and creates a file event for a respective identified file within the scope (operation 160). In some embodiments, the file event is an open-file event. Then, agent 158 intercepts the bits of the opened file (operation 161). Agent 158 subsequently sends the intercepted data bits to endpoint library 146 via multiplexer 156 (communications 168-1 and 168-2). A scan engine within scanning VM 192 in turn scans the received bits. Communication 168 continues until all data bits within the scanning scope of the request are scanned. In some embodiments, instead of sending actual bits to the scan engine, agent 158 can provide the location of the data to be scanned (e.g., a memory or disk address pointer), and the scan engine can obtain the data bits directly from that location.

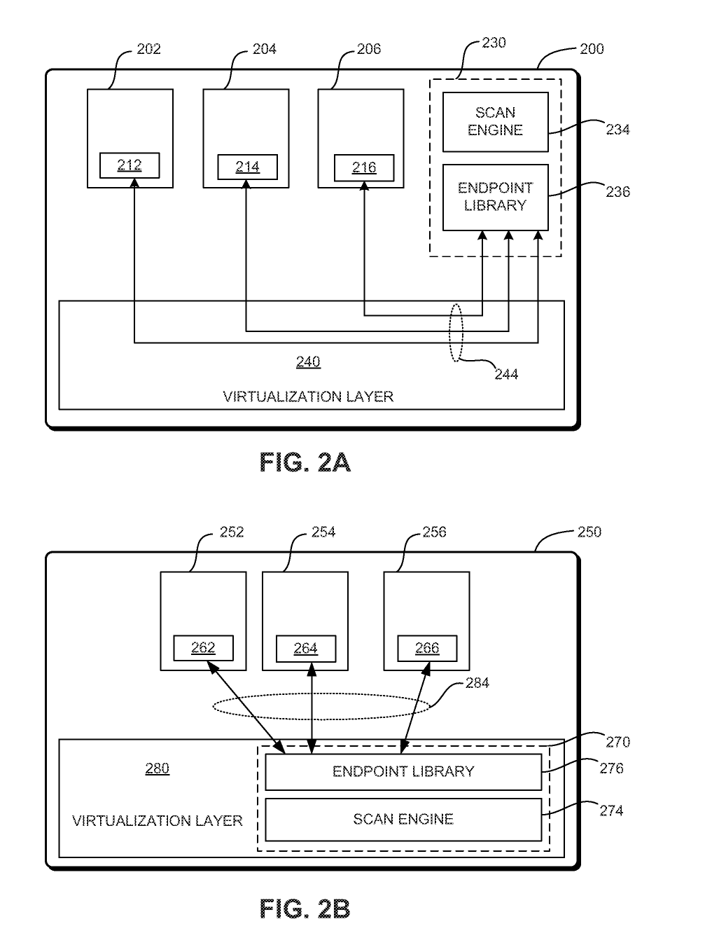

The communication between a guest VM and a scanning VM can be facilitated by the virtualization layer on the host machine. FIG. 2A illustrates an exemplary endpoint security solution on a scanning virtual machine coupled to a guest virtual machine via a virtualization layer. A host machine 200 has a virtualization layer 240 which couples a scanning VM 230 with guest VMs 202, 204, and 206. Agents 212, 214, and 216 run on guest VMs 202, 204, and 206, respectively. Scanning VM 230 includes an endpoint library 236 and a scan engine 234. Endpoint library 236 communicates with agent 212 for performing a scan operation on guest VM 202. Similarly, agents 214 and 216 facilitate scan operation on guest VMs 204 and 206, respectively.

Communication 244 between a respective guest VM (e.g., guest VM 206) and scanning VM 230 is provided by virtualization layer 240. In other words, virtualization layer 240 acts as a dispatcher between a scanning VM and a guest VM. During operation, virtualization layer 240 performs the operation of multiplexer 150 in FIG. 1A and provides communication between agents 212, 214, and 216, and endpoint library 236. In some embodiment, virtualization layer includes a multiplexer module for facilitating communication 244 between guest VMs and scanning VM 230, as described in conjunction with FIG. 1A.

In some embodiments, the scanning VM can be a module in the virtualization layer on the host machine. FIG. 2B illustrates an exemplary endpoint security solution on a virtualization layer coupled to a guest virtual machine. A host machine 250 has a virtualization layer 280 which includes a scanning VM module 270. Communication 284 between guest VMs 252, 254, and 256 and scanning VM 270 is provided by virtualization layer 280. Though only three guest VMs are shown in FIG. 2B, host machine 250 can host any number of guest VMs. Agents 262, 264, and 266 run on guest VMs 252, 254, and 256, respectively. Scanning VM module 270 includes an endpoint library 276 and a scan engine 274 of an endpoint security solution. Endpoint library 276 communicates with agent 262 for performing a scan operation on guest VM 252. Similarly, agents 264 and 266 facilitate scan operation on guest VMs 254 and 256, respectively.

Communication 284 between a respective guest VM (e.g., guest VM 252) and scanning VM module 270 is essentially between the guest VM and virtualization layer 280. During operation, agents 262, 264, and 266 communicate with endpoint library 276 in scanning VM module 270 via virtualization layer 280. For example, when scan engine 274 initiates an on-demand scan for guest VM 254, virtualization layer 280 sends the corresponding request to agent 264. Similarly, virtualization layer 280 forwards data bits from agent 264 to endpoint library 276, as described in conjunction with FIG. 1A.

### Architecture

A virtualization layer on a host machine can run several guest VMs. A respective guest VM can run a guest operating system (OS) like a native operating system. In some embodiments, a guest OS can provide additional support for running on a virtual machine. The guest operating system includes a guest kernel which runs guest applications. The virtualization layer provides a respective guest VM with a set of virtual hardware on which the respective guest OS runs. Virtual hardware for guest VMs share computing resources, such as processor, memory, and storage. For example, a respective guest VM is presented with a virtual disk. The virtual disk is implemented in one or more image files on a physical disk. The guest OS and guest applications write to the image file with the perception that they are storing information in the virtual disk. Hence, when a scanning VM on the host machine sends a request for an on-demand scan to a guest VM, the scope of the scan defines the parts of the image files of the guest VM that should be scanned.

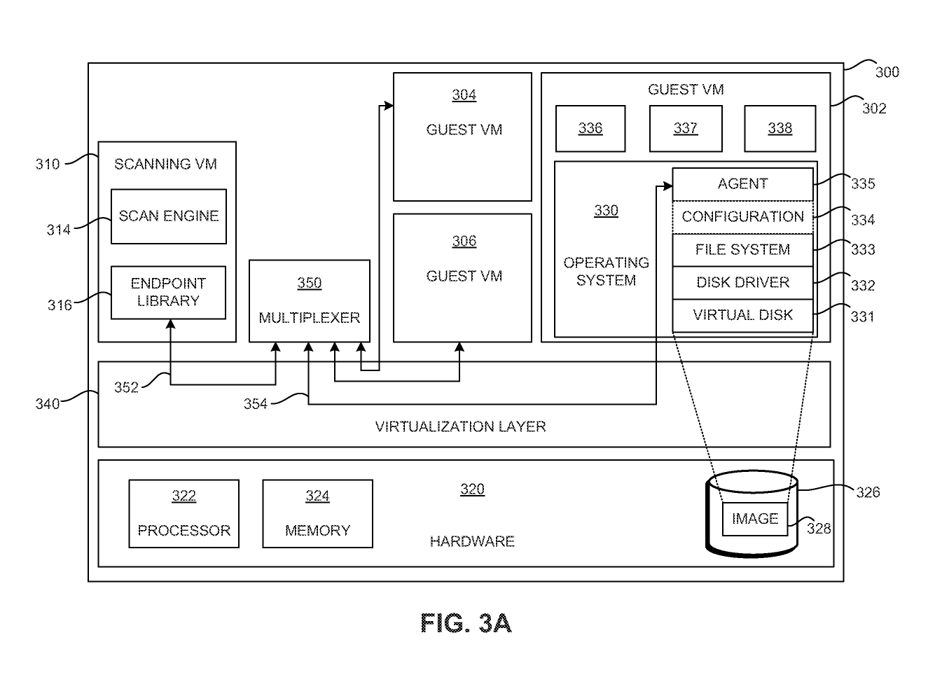

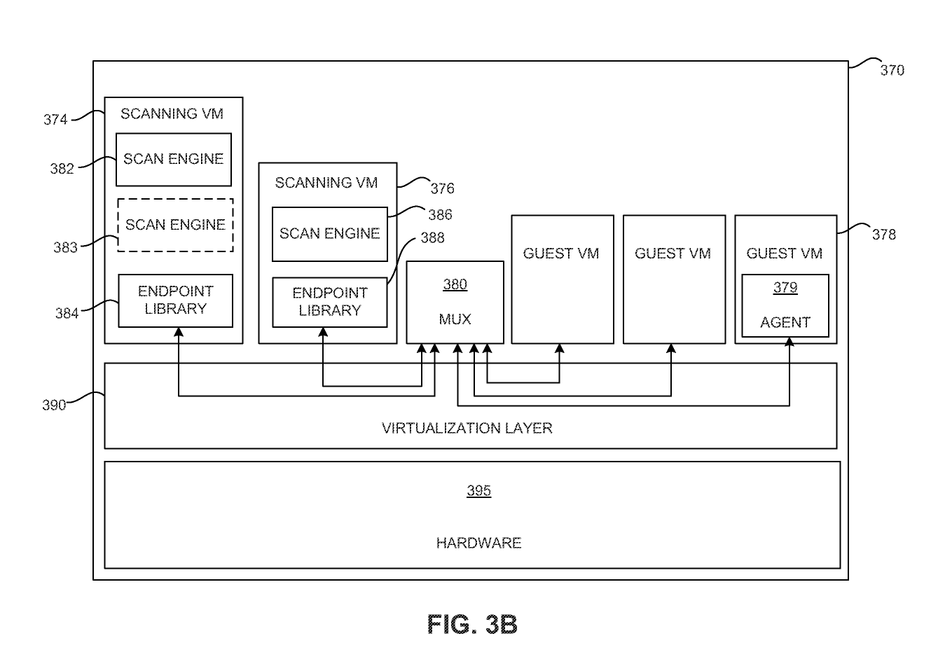

FIG. 3A illustrates an exemplary host machine with a scanning virtual machine and a plurality of guest virtual machines. In this example, a host machine 300 has physical hardware 320 which includes a processor 322, a memory 324, and a storage disk 326. Virtualization layer 340 runs on hardware 320. Scanning VM 310, and guest VMs 302, 304, and 306 run on top of virtualization layer 340. Scanning VM 310 includes a scan engine 314 and an endpoint library 316. Guest VM 302 includes a guest OS 330. Guest applications 336, 337, and 338 run on guest OS 330.

Guest OS 330 includes a disk driver 332, which presents virtual disk 331 to OS 330 as a storage device. In some embodiments, disk driver 332 is a paravirtualized guest driver for virtual disk 331. Virtualization layer 340 represents virtual disk 331 as an image file 328 on physical disk 326. When guest OS 330 accesses any file on virtual disk using a system call through disk driver 332, virtualization layer 340 intercepts calls from disk driver 332 and forwards requests as needed to physical disk 326.

Virtual disk 331 can be formatted using a specific file system 333 depending on the preference of guest OS 330. For example, if guest OS 330 is Linux, then file system 331 can be ext3. Furthermore, virtual disk 331 can optionally contain several configurations. Such configuration may include, but is not limited to, encryption, disk compressions, and disk fragmentation. Agent 335 operates on top of configuration 334. This way, agent 335 can access virtual disk through the configuration. For example, if virtual disk 331 is encrypted, agent 335 can access the decrypted data on the disk through the configuration and file system. In some embodiments, agent 335 does not operate on top of configuration 334. Under such a scenario, agent 335 obtains configuration parameters externally. For example, if virtual disk 331 is encrypted, agent 335 obtains the encryption key and decrypts the data on virtual disk 331.

Guest VMs in host machine 300 are coupled to scanning VM 310 via a logical multiplexer 350. During operation, scan engine 314 initiates an on-demand scan for guest VM 302. Endpoint library 316 creates a request specifying the scope of the scan and sends the request to agent 335 via multiplexer 350. In some embodiments, communication 352 between scanning VM 310 and multiplexer 350 is performed using VMCI. In further embodiment, communication 354 between multiplexer 350 and guest VM 302 is performed using a TCP/IP socket.

Upon receiving the request, agent 335 spawns a thread for the request. The spawned thread then identifies one or more files on virtual disk 331 based on the scope of the request, and creates a file event for the identified file(s). Since the agent operates on top of file system 333 and configuration 334, the thread can directly open the file in virtual disk 331. When the file is opened, agent 335 intercepts the file and provides the bits to scan engine 314. Note that agent 335 tags the intercepted bits as “on-demand.” This tag allows scan engine 314 to determine whether it is scanning bits in response of a scan request, or is scanning the bits as part of an on-access scan policy.

The above-mentioned modules can be implemented in hardware as well as in software. In some embodiments, one or more of these modules can be embodied in computer-executable instructions stored in a memory which is coupled to one or more processors in host machine 300. When executed, these instructions cause the processor(s) to perform the aforementioned functions.

In some embodiments, a host machine can include multiple scanning VM. FIG. 3B illustrates an exemplary host machine with a plurality of scanning virtual machines and a plurality of guest virtual machines. In this example, a host machine 370 has physical hardware 395 on which a virtualization layer 390 runs. Scanning VM 374, scanning VM 376, and several guest VMs also run on virtualization layer 390. One such guest VM 378 includes agent 379. Scanning VM 374 includes scan engine 382 and endpoint library 384. Similarly, scanning VM 376 includes scan engine 386 and endpoint library 388. Both scanning VMs are coupled to guest VMs via a logical multiplexer 380.

During operation, scan engines 382 and 388 initiate two on-demand scans for guest VM 378, respectively. Endpoint library 384 creates a request specifying the scope of the scan and sends the request to agent 379 via multiplexer 380. Similarly, endpoint library 388 sends a request to agent 379 for another scan. Agent 379 spawns two separate threads for two requests. A respective thread creates file events corresponding to each request and sends bits associated with the respective file event to the corresponding scan engine. In this way, a single agent 379 can service on-demand scan requests from multiple endpoint libraries. Furthermore, agent 379 associates a respective thread identifier with the corresponding endpoint library. As a result, the correct data can be forwarded to the right endpoint library. For example, during a communication from the thread associated with endpoint library 388, to the thread identifier can be used to direct the intercepted bits to scanning VM 376.

A scanning VM can include multiple scan engines from different endpoint security applications. For example, scanning VM 374 can also include scan engine 383. Under such a scenario, endpoint library 384 assigns different identifiers to scans initiated from scan engines 382 and 383. Agent 379, in turn, spawns separate threads for the scans. In some embodiments, agent 379 associates a thread with an endpoint library and a scan engine. During a communication from the thread associated with endpoint library 384 and scan engine 383, the thread identifier is used to direct the communication to correct scan engine. Upon receiving the communication, endpoint library 384 checks to which scan engine the communication belongs. In this example, endpoint library 384 determines that the communication is for scan engine 383 and acts accordingly.

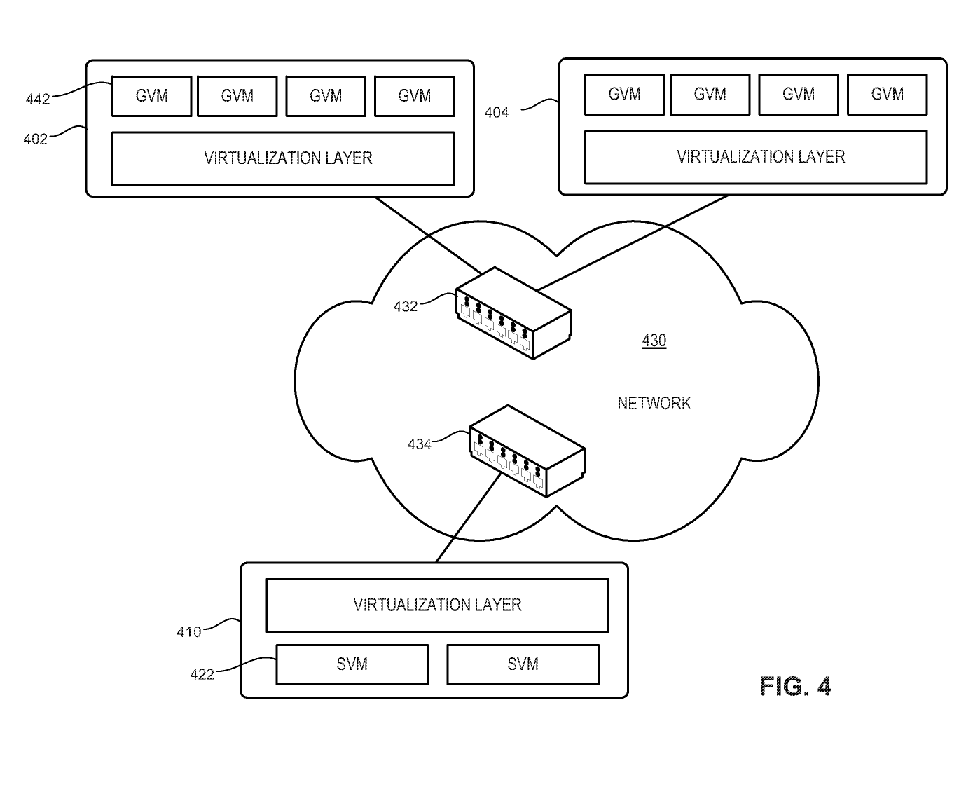

In some embodiments, a host machine can be dedicated for scanning VMs. FIG. 4 illustrates an exemplary network with a host machine dedicated for scanning virtual machine. Host machines 402 and 404 host several guest VMs, and are coupled to network 430 via switch 432. Host machine 410 is dedicated for scanning VMs and coupled to network 430 via switch 434. In some embodiments, switch 432 and switch 434 can be routing devices. Network 430 can be a local network or the Internet. A scanning VM on host machine 410 can initiate an on-demand scan request for a guest VM hosted on any other host machine coupled to network 430. For example, scanning VM 422 can initiate an on-demand scan on guest VM 442 on host machine 402. Instead of communicating via a multiplexer, as described in conjunction with FIG. 3A, scanning VM 422 and guest VM 442 communicate using network sockets. An endpoint library on scanning VM 422 and an agent on guest VM 442 works the same way as described in conjunction with FIG. 3A.

### Execution

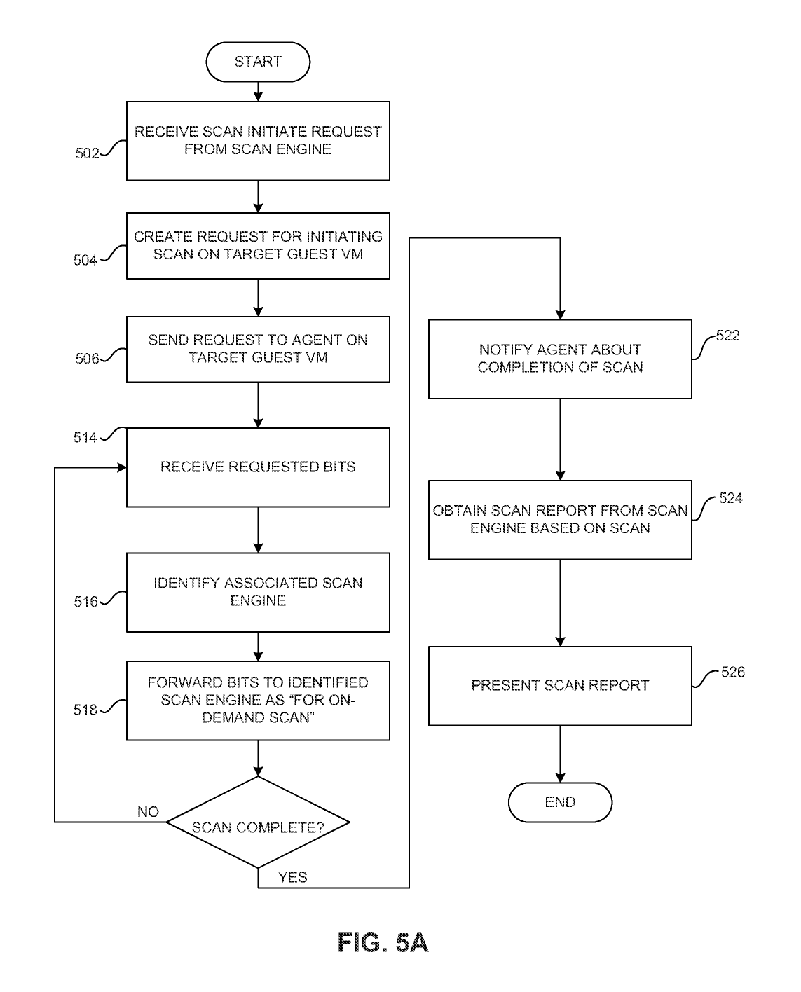

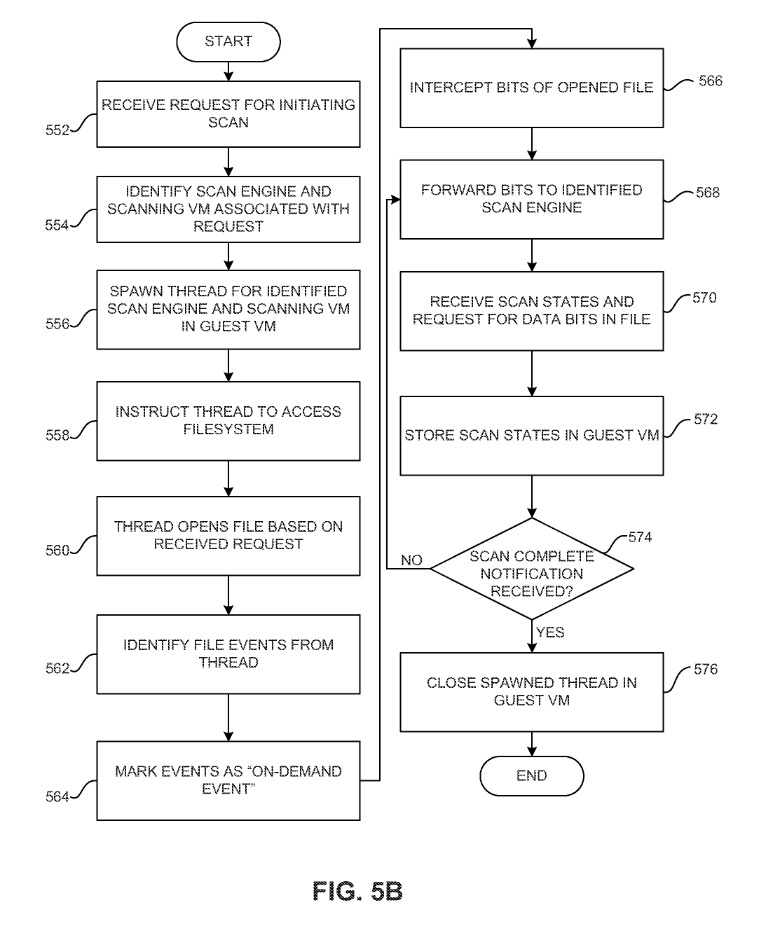

FIG. 5A presents a flowchart illustrating an exemplary process of an on-demand data scan in a scanning virtual machine. During operation, the endpoint library on a scanning VM first receives a scan request from the scan engine (operation 502). In some embodiments, the scan engine is part of an endpoint security solution which provides a user interface to a user for initiating the scan. The endpoint library then creates a request for initiating the scan on a target guest VM (operation 504) and sends the request to an agent on the target guest VM (operation 506). The endpoint library, in response, receives the requested bits from the agent (operation 514).

Note that the endpoint library can serve multiple scan engines and associated an identifier with a respective scan engine. The endpoint library identifies the scan engine associated with the scan operation (operation 516) and forwards the received bits to the identified scan engine (operation 518). In some embodiments, the endpoint library identifies a tag associated with the received bits which indicate that these bits are for an on-demand scan, and notifies the scan engine accordingly. If the endpoint library is associated with only one scan engine, operation 516 may be optional. The endpoint library then checks with the scan engine whether the scan operation is complete (operation 520). If so, then the endpoint library notifies the agent about the completion of the scan (operation 522), obtains scan report from the scan engine based on the scan operation (operation 524), and presents the scan report to a user (operation 526). The endpoint library may present the scan report via a graphical user interface or in a data file. If the scan operation is not complete, then the endpoint library s continues to receive data bits until all bits within the scan scope are scanned (operation 520).

FIG. 5B presents a flowchart illustrating a process of an endpoint agent in a guest virtual machine facilitating an on-demand data scan. During operation, the agent first receives a request to initiate an on-demand scan from an endpoint library (operation 552). Because a single agent can serve multiple scanning VMs and scan engines, sometimes concurrently, the agent optionally identifies the scanning VM and the scan engine associated with the request (operation 554). In some embodiments, the agent identifies the endpoint library to identify the associated scanning VM. The agent then spawns a thread for the scanning VM and the scan engine (operation 556). Using individual threads for a respective scanning VM and scan engine enables the agent to compartmentalize and serve multiple, even concurrent, scan requests. The agent then instructs the spawned thread to access the file system (operations 558). The thread subsequently opens the files specified in the request (operations 560).

The agent obtains the file events from the thread (operations 562) and marks the file events as “for on-demand scan” (operation 564). In some embodiments, the agent sets a flag to mark the file content as “for on-demand scan.” The agent then intercepts the bits of the opened file (operation 566) and forwards the intercepted bits to the identified scan engine on the scanning VM (operation 568). In some embodiments, the agent also receives scan states from the endpoint library (operation 570), and stores the scan states in the guest VM, i.e., writes the scan states in the guest VM image, as described in conjunction with FIG. 3A (operation 572). The scan state information can include, for example, the scope of the scan (e.g., list of files or directories to be scanned), files with completed scans, files currently being scanned, and files yet to be scanned within the scope. The files currently being scanned may be files for which contents have been or are being transmitted to the security application and for which the agent has not yet received an acknowledgement from the security application. The agent then checks whether a notification from the endpoint library indicating the completion of the scan has been received (operation 574). If so, the agent terminates the spawned thread (operation 576). Otherwise, the agent continues to send intercepted bits to the scan engine (operation 568) until the agent receives a notification from the endpoint library indicating the completion of the scan (operation 574).

### VM Migration

A guest VM running on a host machine can migrate to a different host machine. When the guest VM migrates to a new host machine, a new scanning VM starts managing endpoint security solutions for the migrating guest VM. If the guest VM has been undergoing a scan initiated by a scanning VM on the original host machine, the new scanning VM should continue the scan operation. A VM migration includes transferring one or more image files of the VM to the new location. If the image file of the VM contains the scan states of the ongoing scan, then the new scanning VM can obtain the states and continue the scan operation.

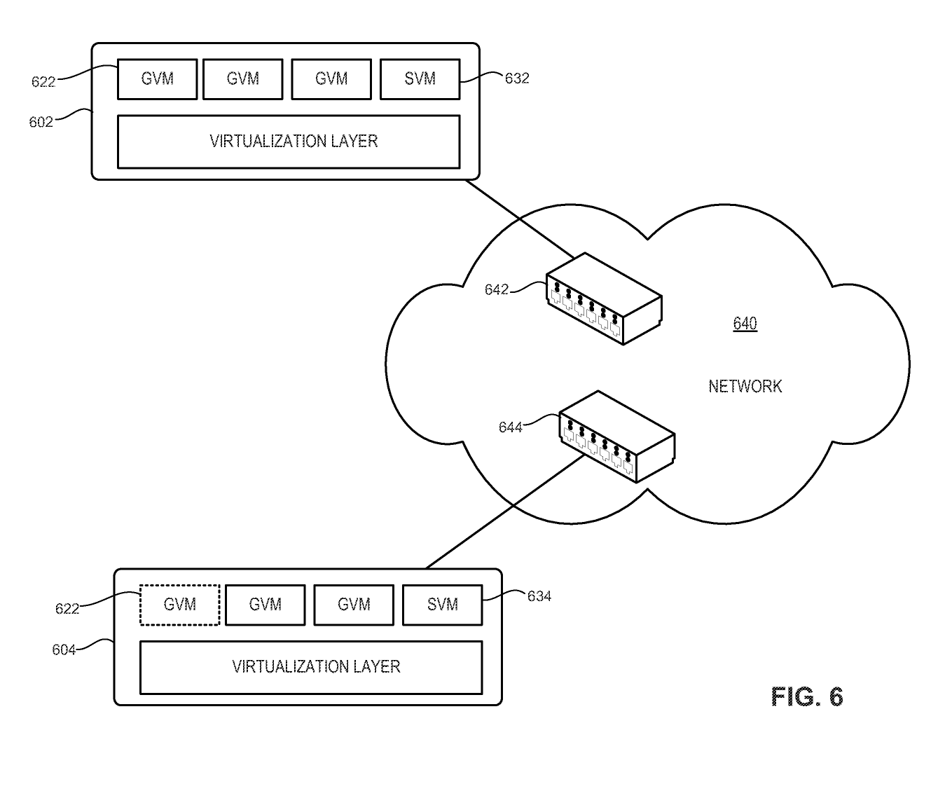

FIG. 6 illustrates an exemplary migration of a guest virtual machine. Host machines 602 and 604 host several VMs, and are coupled to network 630 via switches 632 and 634, respectively. During operation, scanning VM 632 in host machine 602 runs an on-demand scan operation on guest VM 622. While scanning VM 632 receives data bits for the scan, the corresponding scan states are stored in guest VM 622, as described in conjunction with FIGS. 5A and 5B. During the ongoing scan operation, guest VM 622 migrates to host machine 604 (denoted with dotted lines). Scanning VM 634 then becomes responsible for managing endpoint security solutions for guest VM 622. During the migration, the scan states of the ongoing scan have been transferred with the image files to new host machine 604. New scanning VM 634 then obtains the states and continues the scan operation. In some embodiments, a logical multiplexer running on host machine 604 receives a signal from the local virtualization layer, becomes aware of the new guest VM 622, and sends the notification to the endpoint library running on scanning VM 634. In some embodiments, the logical multiplexer can be part of the virtualization layer in host machine 604. As a result, whenever a new guest VM migrates to host machine 604, the multiplexer becomes aware of the new guest VM running on the virtualization layer.

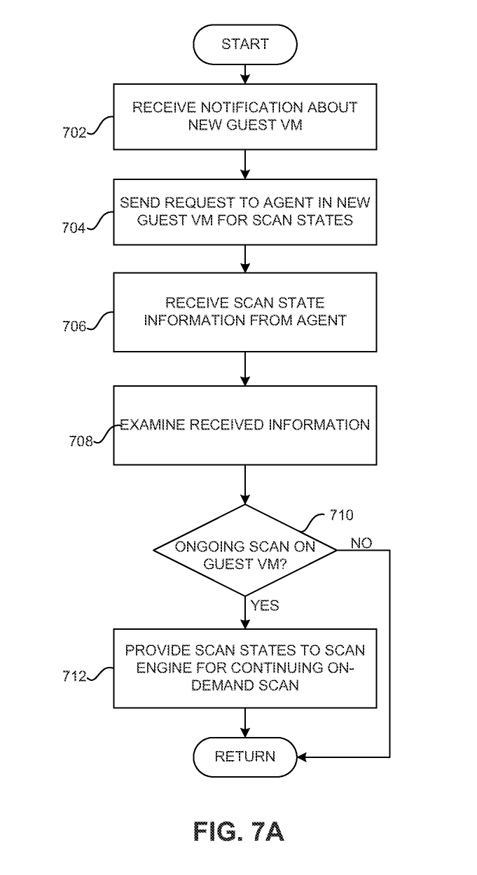

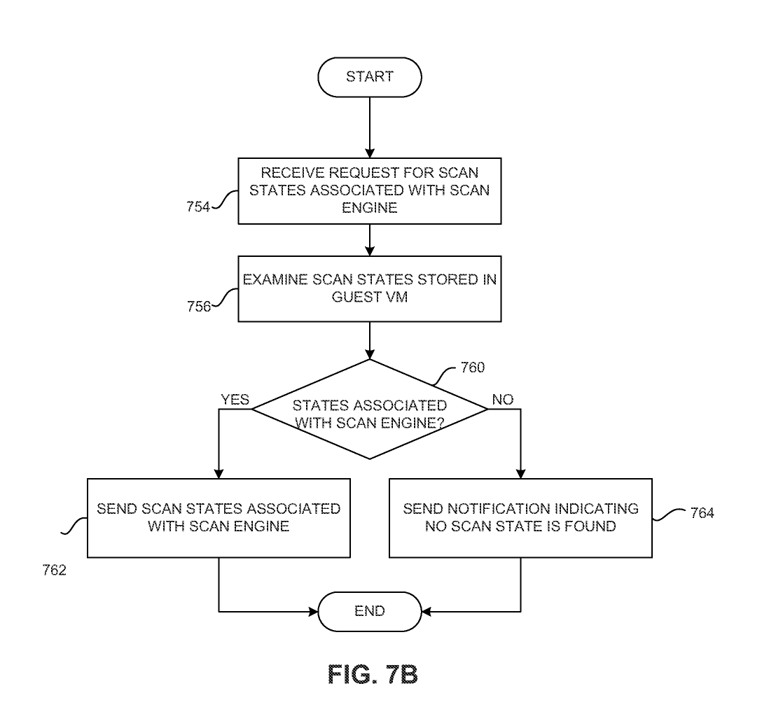

FIG. 7A presents a flowchart illustrating a process of an endpoint library in a scanning virtual machine discovering a migrating guest virtual machine. The endpoint library first receives a notification about a new migrating guest VM (operation 702). In some embodiments, the notification is generated by a logical multiplexer residing on the host machine on which the scanning VM runs. Upon receiving the notification, the endpoint library sends a request to the agent in the migrating guest VM for current scan states (operation 704). The request can contain identifying information about the scan engines running on the scanning VM. The endpoint library, in response, receives the scan state information from the agent (operation 706). In some embodiments, the information can include a notification indicating that no ongoing scan is present in the guest VM. The endpoint library then examines the received information (operation 708) and checks whether there is an ongoing scan associated with the scan engines running on the scanning VM (operation 710). If there is an ongoing scan, then the endpoint library provides the corresponding scan engines with the received scan state information (operation 712). The endpoint library then continues facilitating the scan operation, as described in conjunction with FIG. 5A.

FIG. 7B presents a flowchart illustrating a process of an endpoint agent in a migrating guest virtual machine providing scan state information. After the migration of the guest VM to a new host machine, the agent receives a request for scan states associated with a scan engine from an endpoint library in a scanning VM in the new host (operation 754). The agent, in response, examines scanned states stored in the guest VM (operation 756), and checks whether any scan state corresponding to the scan engine is stored (operation 760). For example, the agent can check whether the states of an on-going AV scan are stored, which correspond to an AV scan engine on the new host. If no scan state associated with the scan engine is found, the agent sends a corresponding notification indicating that no scan state is found (operation 764). Otherwise, the agent sends the scan states associated with the scan engine to the endpoint library (operation 762).

In summary, the present disclosure presents an inventive system that facilitates on-demand data scan operation in a guest virtual machine. During operation, the system generates an on-demand scan request at a scanning virtual machine, wherein the request specifies a scope for the on-demand scan. The system communicates the on-demand scan request to the guest virtual machine and receives data from the guest virtual machine in response to the request. The system identifies the data as candidate for on-demand scanning and scans the data in furtherance of a security or data integrity objective. The methods and processes described herein can be embodied as code and/or data, which can be stored in a computer-readable non-transitory storage medium. When a computer system reads and executes the code and/or data stored on the computer-readable non-transitory storage medium, the computer system performs the methods and processes embodied as data structures and code and stored within the medium.

The methods and processes described herein can be executed by and/or included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The foregoing description has been presented only for purposes of illustration and description. They are not intended to be exhaustive or limiting. Accordingly, many modifications and variations will be apparent to practitioners skilled in the art. The scope of the present invention is defined by the appended claims.

What is claimed is:

1. A computer-executable method for on-demand data scan operation in a guest virtual machine, comprising:
generating an on-demand scan request at a scanning virtual machine, wherein the request specifies a scope for the on-demand scan;
communicating the on-demand scan request to the guest virtual machine;
receiving data from the guest virtual machine in response to the request;
identifying the data as candidate for on-demand scanning; and
scanning the data in furtherance of a security or data integrity objective.

2. The method of claim 1, wherein the request is communicated to the guest virtual machine via a logical multiplexer.

3. The method of claim 1, wherein communication between the scanning virtual machine and the guest virtual machine is performed based on one or more of the following:
a Transmission Control Protocol (TCP)/Internet Protocol (IP) socket;
a User Datagram Protocol (UDP) socket;
a Virtual Machine Communication Interface (VMCI);
a shared memory in a host machine; and
a Small Computer System Interface (SCSI) layer communication protocol.

4. The method of claim 1, further comprising receiving a notification about a new guest virtual machine in a host machine.

5. The method of claim 4, further comprising receiving a scanning state from the new guest virtual machine, wherein the scanning state specifies any ongoing scan operation on the new guest virtual machine.

6. The method of claim 1, wherein identifying the data as candidate for on-demand scanning comprises evaluating one or more flags associated with the data.

7. The method of claim 1, wherein the objective is associated with one or more of the following:
an anti-virus application;
a file integrity-checking application;
a data leak prevention application; and
an anti-malware application.

8. A computer-executable method for facilitating on-demand data scan in a guest virtual machine, comprising:
receiving from a scanning virtual machine a request for an on-demand scan on the guest virtual machine;
creating a file event associated with the request;
intercepting data associated with the file event;
communicating the intercepted data to the scanning virtual machine; and
storing state information associated with the scan in the guest virtual machine.

9. The method of claim 8, wherein creating the file event comprises initiating a thread to access all files within a scope specified in the on-demand scan request.

10. The method of claim 8, further comprising communicating to the scanning virtual machine a notification about a virtual machine migration operation.

11. The method of claim 8, further comprising communicating state information to the scanning virtual machine.

12. The method of claim 8, further comprising servicing multiple data scan request concurrently.

13. A non-transitory computer-readable storage medium storing instructions that when executed by a computer cause the computer to perform a method for on-demand data scan operation in a guest virtual machine, the method comprising:
generating an on-demand scan request at a scanning virtual machine, wherein the request specifies a scope for the on-demand scan;
communicating the on-demand scan request to the guest virtual machine;
receiving data from the guest virtual machine in response to the request;
identifying the data as candidate for on-demand scanning; and
scanning the data in furtherance of a security or data integrity objective.

14. The storage medium of claim 13, wherein the request is communicated to the guest virtual machine via a logical multiplexer.

15. The storage medium of claim 13, wherein communication between the scanning virtual machine and the guest virtual machine is performed based on one or more of the following:
a Transmission Control Protocol (TCP)/Internet Protocol (IP) socket;
a User Datagram Protocol (UDP) socket;
a Virtual Machine Communication Interface (VMCI);
a shared memory in a host machine; and
a Small Computer System Interface (SCSI) layer communication protocol.

16. The storage medium of claim 13, wherein the method further comprises receiving a notification about a new guest virtual machine in a host machine.

17. The storage medium of claim 16, wherein the method further comprises receiving a scanning state from the new guest virtual machine, wherein the scanning state specifies any ongoing scan operation on the new guest virtual machine.

18. The storage medium of claim 13, wherein identifying the data as candidate for on-demand scanning comprises evaluating one or more flags associated with the data.

19. The storage medium of claim 13, wherein the objective is associated with one or more of the following:
an anti-virus application;
a file integrity-checking application;
a data leak prevention application; and
an anti-malware application.

20. A non-transitory computer-readable storage medium storing instructions that when executed by a computer cause the computer to perform a method for testing in object-oriented programming for a multi-threaded application, the method comprising:
receiving from a scanning virtual machine a request for an on-demand scan on the guest virtual machine;
creating a file event associated with the request;
intercepting data associated with the file event;
communicating the intercepted data to the scanning virtual machine; and
storing state information associated with the scan in the guest virtual machine.

21. The storage medium of claim 20, wherein creating the file event comprises initiating a thread to access all files within a scope specified in the on-demand scan request.

22. The storage medium of claim 20, wherein the method further comprises communicating to the scanning virtual machine a notification about a virtual machine migration operation.

23. The storage medium of claim 20, wherein the method further comprises communicating state information to the scanning virtual machine.

24. The storage medium of claim 20, wherein the method further comprises servicing multiple data scan request concurrently.
